(19) United States
(12) Patent Application Publication
(10) Pub. No.: US 2005/0114196 A1
(43) Pub. Date: May 26, 2005

(54) Product assortment optimization systems, products and methods

(76) Inventor: Tor Schoenmeyr, Cambridge, MA (US)

Correspondence Address: INNA SHTIVELBAND LANDSMAN, 129 RAWSON RD, ARLINGTON, MA, 02474, US

(21) Appl. No.: 10/718,354

(22) Filed: Nov. 20, 2003

(51) Int. Cl. G06F 17/60

(52) U.S. Cl. 705/10

(57) ABSTRACT

Systems, products and methods are provided for optimizing an assortment of product or services. The method comprises the steps of (a) categorizing the product assortment into a plurality of categories, (b) calculating a performance function for each category that describes the relationship between the number of products in the category and the performance of that category, wherein the performance function predicts the effect of removing or adding category products on performance of the category, and (c) improving the retailer's total performance by determining the number of products to sell in each category based on the performance function for each category.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

In retail operations of all kinds (from a local liquor store to a massive Internet sales portal) retailers provide an assortment of products to their customers. Naturally, the retailers want to select this assortment in such a way that it brings them the maximum benefit in terms of revenues and profits.

In the last decades the dramatic developments of computers and the Internet have made it possible to collect large amounts of data and analyze them with powerful tools. This has led to a number of inventions in the field of retail operations. For example, inventions disclosed in U.S. Pat. No. 5,596,493 (Tone et al) and U.S. Pat. No. 5,615,109 (Eder) discuss at what times and in what quantities a retailer should place orders with its suppliers. U.S. Pat. No. 5,313,392 (Temma et al) and U.S. Pat. No. 4,642,780 (Thompson) describe methods for optimizing the layout of a store. Other U.S. patents such as U.S. Pat. No. 6,029,139 (Cunningham) reveal inventions drawn to optimizing promotional campaigns.

However, the very important question of which products should be carried has remained largely unanswered. Ursey in U.S. Pat. No. 6,366,890 made a contribution by showing how to aggregate data from multiple sources and compare the number of products with share of sales in a market. This method is particularly useful for identifying individual products that should be replaced with more popular substitutes, as a user can compare how his or her categories performs next to the market at large. For example, if a retailer has 5 types of potato chips and these are not the 5 best selling on the market, Ursey's invention will make this clear. Occasionally this can be misleading because a product's total sales in a market are affected not only by the intrinsic popularity of the product but also by the number of retailers that carry it. A retailer that uses Ursey's invention extensively might act mostly reactively to what is being sold by its major competitors. A new product that sells extremely well, but only at a few places, is likely to be ignored because its fraction of market sales is small.

A more serious shortcoming in the field in general, however, is the lack of analytic tools for more strategic assortment decisions. In particular there is little guidance about what categories to expand, to reduce or to remove in a retail operation. The work of Ursey and others (for example U.S. patent application 20030083915) help a retailer identify when individual products should be replaced with more popular varieties, but this is only useful for optimization within a category. They offer little guidance about when to replace a product not with a substitute but with something completely different. Such questions are complicated a great deal by so called substitution and cannibalization effects. When a product is introduced or removed, this will affect the sales of other products in the same category. Ursey and others have mostly ignored this complication, because if you only replace a product with a more popular substitute; then the end result will almost certainly be positive regardless of the exact extent of substitution. However, when you are considering expanding one category at the expense of another, then a good understanding of these substitution effects becomes vital. However, up until now retail managers have given up when forced to compare the proverbial apple and orange, and resorted to inadequate tools and guesswork.

A popular tool used by the skilled artisan is the plot of ordered distributions of products versus sales in a market. This is a curve that shows number of products in a market versus sales in that market (or percentages thereof). A retail manager could look at such data when making decisions, but it is not clear what strategic conclusions he or she should draw. As interesting as these curves may be, they offer little predictive power over what is likely to happen if new products are introduced. As a simple example, if there are two similar and equally selling products in a market, the plot will tell us that one product sells 50% and that their cumulative sales are 100%. Imagine now that we are selling one of those products and are considering the consequences of also adding the other to our assortment. A simple mistake after reading such a graph may be to believe that our category sales would double by such an action. Experienced managers know that this is an incorrect inference because the graph reveals nothing of how products substitute in a store with a particulate assortment. Indeed, a retail manager has had little choice but to rely on guesswork or rules of thumb to make such vitally important strategic decisions.

### BACKGROUND OF THE INVENTION—OBJECTS AND ADVANTAGES

The objects and advantages of the present invention are thus to provide systems, products and methods that are useful in optimizing a retail product assortment beyond the point of exchanging poor products for better selling varieties. This means determining which categories should be expanded and which should be reduced or removed; even if the categories are of different nature and substitution effects uncertain.

This optimization can be done to bring the maximum benefit from a fixed number of products or to a limited retail space.

Additional benefits include an increased understanding of substitution effects within the categories and alternative costs within the categories. Thus a retailer can assess the merit of an existing product not based on how well it sells, but rather on the likely change in category sales if the product is removed. The latter is a superior metric if for example one has a minimum performance threshold (cost-to-carry) for all products.

In spite of these substantial improvements, the present invention does not rely on massive external data sets like much of the previous work. Such data is expensive for mainstream retail sectors and difficult or impossible to get for niche sectors. Rather, the present invention puts limited internal sales data to the maximum use.

### SUMMARY

The invention provides methods, products, and systems for optimizing a retailer's product assortment.

In one embodiment, the invention provides a method for improving a retailer's total performance of a product assortment. The steps include (a) categorizing the product assortment into a plurality of categories; (b) calculating a performance function for at least one category that describes the relationship between the number of products in the category and the performance of that category, wherein the performance function predicts the effect of removing or adding products to the category on category performance, and (c) improving the retailer's total performance by determining the number of products to sell in each category based on the performance function for each category. The product assortment is preferably categorized according to substitutability, and products in each category are preferably ordered according to performance. Products that are always or sometimes substituted for each other are preferably placed in the same category. Performance may be defined as revenue, profit or number of units sold, any of the foregoing divided by product size, or any other similarly useful metric. The step of improving the retailer's total performance preferably includes determining the number of products in each category whose addition to the category meets a performance measure. Alternately, the step of improving the retailer's total performance includes finding the number of products in each category which generate the optimized sum performance for all categories.

In one embodiment, the performance function is calculated based on the retailer's performance data and product assortment and/or from retail data from different time periods. In another embodiment, at least one performance function has a diminishing performance for each additional product added. Preferably, each performance function shows a performance value of zero when zero products are sold.

In another embodiment, the invention provides one or more computer-readable media having computer executable program instructions that, when executed, direct a computing system to: (a) categorize the product assortment into a plurality of categories, (b) calculate a function for each category that describes the relationship between the number of products in the category and the performance of that category, wherein the performance function predicts the effect of removing or adding category products on performance of the category, and (c) improve the retailer's total performance by determining the number of products to sell in each category based on the performance function for each category.

In one embodiment, the computer readable media of the invention further has program instructions that, when executed, direct a computer system to categorize the product assortment by categorizing the product assortment according to substitutability, and preferably to categorize products into the same category if they are always or sometimes substituted for each other. Preferably, the program instructions, when executed direct the computer system to order the products in each category according to performance.

In one embodiment, the program instructions for improving the retailer's total performance, when executed, direct the computer system to determine the number of products in each category whose addition to the category meets a performance measure. In another embodiment, the computer executable program instructions for improving the retailer's total performance, when executed, direct the computer system to iteratively increase a performance measure that each product must meet until the total number of products across all categories is not greater than the total number of products that the retailer can carry, wherein the performance measure tests the increase in category performance likely to be caused by adding each product to its category.

In another embodiment, the invention provides computer readable media having computer-executable program instructions that, when executed, direct the computer system to calculate at least one performance function based on the retailer's performance data and product assortment, and in yet another embodiment, based on data from different time periods. In another embodiment, the computer-executable program instructions, when executed, direct the computer system to calculate at least one performance function that has a diminishing performance for each additional product added. Preferably, the computer readable media includes computer-executable program instructions that, when executed, direct the computer system to calculate each performance function to have a performance value of zero when zero products are sold.

In yet another embodiment, the invention provides a system for improving a retailer's total performance of a product assortment, including a memory having program instructions that (a) categorize the product assortment into a plurality of categories, (b) calculate a function for each category that describes the relationship between the number of products in the category and the performance of that category, wherein the performance function predicts the effect of removing or adding category products on performance of the category, and (c) improve the retailer's total performance by determining the number of products to sell in each category based on the performance function for each category; and a processor for executing the program instructions. In one embodiment, the system has program instructions for categorizing the product assortment according to substitutability, and preferably program instructions that categorize products into the same category if they are always or sometimes substituted for each other by consumers. Most preferably, the system includes program instructions that order the products in each category according to performance.

In one embodiment, the system has program instructions for improving the retailer's total performance that include determining the number of products in each category whose addition to the category meets a performance measure. In another embodiment, the program instructions for improving the retailer's total performance include iteratively increasing a performance measure that each product must meet until the total number of products across all categories is not greater than the total number of products that the retailer can carry, wherein the performance measure tests the increase in category performance likely to be caused by adding each product to its category. In one embodiment, the system includes program instructions for calculating one or more performance functions based on the retailer's performance data and product assortment. In another embodiment, the system includes program instructions that calculate one or more performance function based on data from different time periods, and preferably performance functions having a diminishing performance for each additional product added. Most preferably, the system has program instructions that calculate performance functions that show a performance value of zero when zero products are sold.

In yet another embodiment, the invention provides a method of categorizing products in a product assortment, by (a) grouping products that customers do not substitute for each other into different categories, and (b) grouping products that customers sometimes or always substitute for each other into the same category. In another embodiment, the method includes the step of ordering the products in each of said categories according to the order of their performance.

### DRAWINGS

The objects and features of the invention will become more readily understood from the following detailed description and appended claims when read in conjunction with the accompanying drawings in which like numerals represent like elements and in which:

FIG. 1 illustrates a system of the invention;

FIG. 2 illustrates the optimization method of the invention in overview;

FIG. 3 illustrates a method of the invention for product categorization;

FIGS. 4A and 4B show plots that conceptually illustrate how performance functions are estimated;

FIGS. 5A-5D illustrate an example of estimating a performance function using a spreadsheet program;

FIG. 6A illustrates an optimization process of the invention that follows the minimal threshold method;

FIG. 6B illustrates an optimization process of the invention that follows the maximum total performance method;

FIGS. 7A and 7B show conceptual graphs illustrating examples of categories being optimized; and

FIGS. 8A-8C show a computer-implemented practical example of the optimization process.

### DETAILED DESCRIPTION OF THE INVENTION

The present invention provides computer systems, products, and methods for improving a retailer's performance by improving its product assortment across multiple categories.

As used herein, the term “optimize” means to improve. It is not used to convey the objectively best solution, but rather a better or improved solution to a particular problem.

As used herein, the word “performance” refers to profit, revenue, number of units sold, or any other measure by which a retailer would find it useful to measure the performance of a product. In some embodiments, “performance” refers to any of the foregoing divided by product size. The use of a performance measure that takes the size of the product into account can be useful for getting the most benefit from a retailer's finite space. It is assumed that the product size of all products in one category is the same.

The term “product” refers to anything which can be or is routinely exchanged for money. Examples include goods and services.

The term “product assortment”, as used herein, refers to some, and preferably all, the products sold by one or more retailer's. The methods, products and systems described herein can be used to optimize the product assortment at one or multiple retail locations.

As used herein, a “retailer” is any business or individual that sells a product, and can include stores, wholesalers, Internet sites, merchants who sell by catalog, and the like.

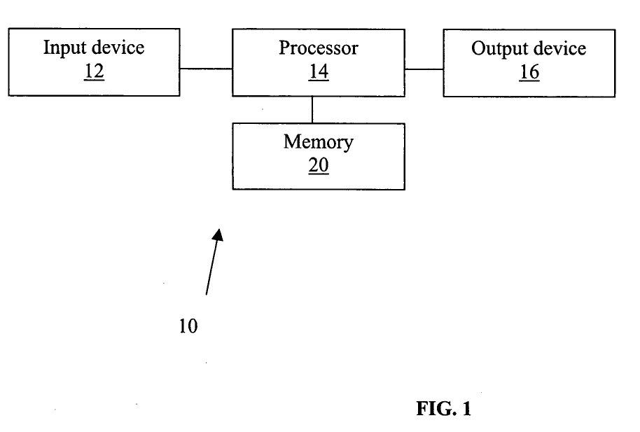

Referring to FIG. 1, a system 10 for improving a retailer's performance includes an input device 12, a processor 14, an output device 16, and memory storing programmed code 20 that controls the operation of the processor 14. One or more input devices 12 may be attached to processor 14, including a keyboard, a mouse, or any other such device. The processor 14 may be a conventional processor that interfaces with the input device 12 to receive inputted data and user commands, and with output device 16. One or more output devices 16 may be attached to processor 14, including a conventional display, a printer, or other such devices. Memory 20 stores program instructions that control the operation of processor 14 through program instructions. The memory 20 may be a permanently installed memory, such as a computer hard drive. Alternatively, the memory 20 may be a portable storage medium, such as a computer disk cartridge, a compact disk cartridge or the like. The entire system 10 may be embodied in a personal computer, laptop computer, notebook computer or the like.

Additionally, the invention provides one or more computer readable media that have instructions for performing the methods described herein.

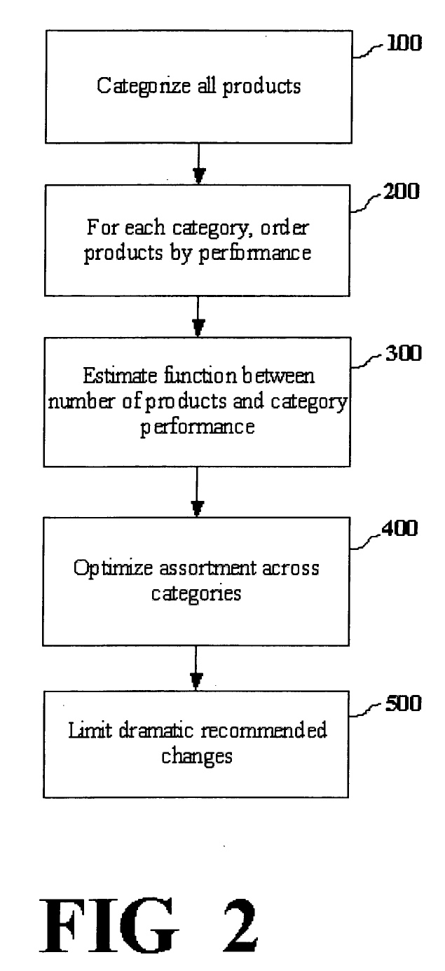

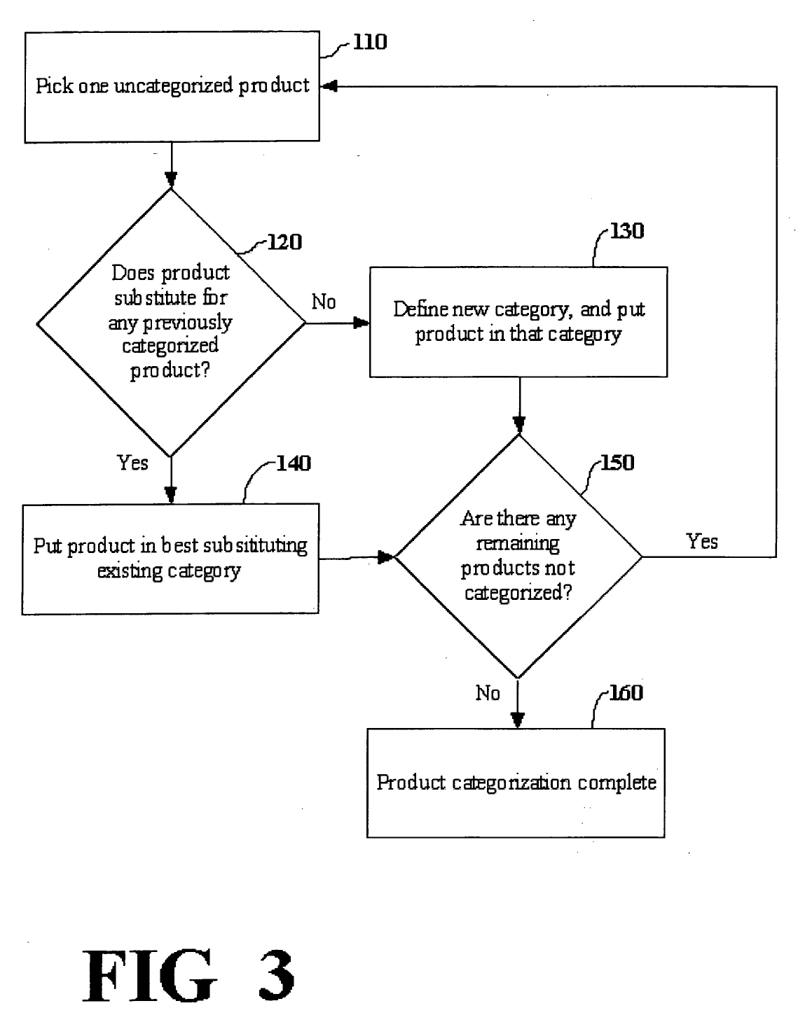

FIG. 2 describes a preferred method of the invention in overview. All products in the retailer's product assortment are categorized in step 100. The categorization process is illustrated in more detail in FIG. 3.

Referring back to FIG. 2, all categorized products are ordered according to their performance, as indicated by step 200. In other words, the highest performing product in each category is ranked as 1^{st}, the second best as 2^{nd}, and so on. This notation has the benefit that if it is later determined through use of the invention to, e.g., “reduce the category to three products” the actual products to be kept are products 1^{st}, 2^{nd}, and 3^{rd}, though other notations can be used within the scope of the invention. Such ordering is also necessary for the performance functions explained below.

The skilled artisan will further understand that products that perform better than other products in the same category are likely to increase the retailer's performance. It is assumed that the current products in each category are already the best that the retailer has managed to identify. For example this can be known or determined from routinely available market data. If the retailer or user of the systems, products or methods of the invention (“user”) is aware of better performing products than the ones presently carried in a category, then substitutions should be made accordingly. The present invention assumes that such relatively obvious modifications have been made, and that we are pursuing the more difficult and rewarding goal of optimizing the whole product assortment across categories.

When products have been ordered within their categories, performance functions should be estimated to describe the relationship between the number of products in each category and the total performance of that category (step 300). The performance function is a mathematical function that describes the relationship between the number of products in a category and the performance of that category, and is further described below. The performance functions of the present invention are quite different from a similar-looking curve which is common in the industry under a variety of names, and which is discussed in the background section, above. Instead of observing that for example the best two products in the market sell for a certain amount, the functions of the invention predict what outcome is likely if the retailer reduces (or increases) its assortment to a different number of products than is currently being sold. Essentially, the present invention replaces market observations with actionable predictions, by taking into account current assortment and likely substitution effects. Once the performance function is estimated, the retailer's total performance is optimized by determining the number of products to sell in each category based on the performance function of each category (step 400).

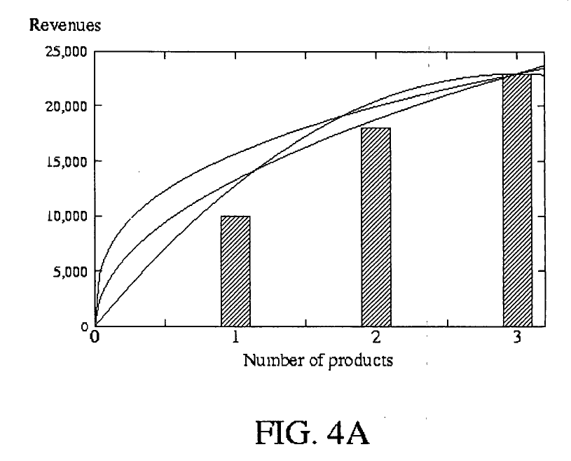

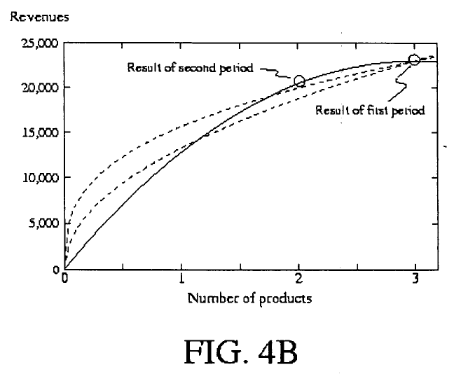

In some embodiments of the invention, some of the more dramatic recommendations may be limited since they are derived from estimates of performance functions (step 500). For example, if a category has 6 products and the user determines that it should be eliminated altogether by use of the invention, then we can instead only reduce it by three products (i.e., a number less than 6). The next time the invention is being used, the user will have an additional data point to confirm (or possibly revise) the performance function used earlier. If the performance function is revised, then the optimal product level is likely to be changed as well. In FIG. 4A we can see that the three proposed performance functions are all quite similar to each other near the current number of products, but less similar for significantly different product numbers. Thus it can be sensible to make changes gradually while gathering more data about less familiar category sizes. Whether a recommendation is “dramatic” can be determined by the user's comfort level, the types of products in the product assortment, the magnitude of the change compared to the original category size, values pre-programmed into the products and systems of the invention or other criteria chosen by the user or maker of the products or systems of the invention.

FIG. 3 illustrates a method for categorizing products according to the invention. An uncategorized product is picked from the product assortment (step 110). ext, in step 120, the question is asked whether the product is a substitute for any other product that has already been categorized (for the first product in a product assortment, of course this will not be the case). Preferably, the term “substitute” should be interpreted as partial substitute; if at least some customers could or do substitute one product for another then these two should be in the same category. Thus if there exists a suitable category, then the product at hand is put in that category (step 140). If a product can be placed in multiple categories, the user will choose the category with products that are most often substituted for the product that is being categorized. But if no substitutable product exists then a new category is created and the product is put into that category (step 130). If any remaining products in the product assortment are not categorized (step 150), then the process starts over at step 110. Thus the process is repeated until all products have been categorized and step 160 has been reached.

A performance function can be estimated based on the retailer's currently available data, past data, market data, or any other data that can be used to correlate the number of products sold in a category with performance of that category. All that is required is one data point (i.e., one correlation between the number of products in a category that are sold at a particular time and performance of that category), though additional data points are useful and increase function accuracy. FIGS. 4A and 4B show prophetic examples of graphed performance functions, and illustrate characteristics of performance functions of the invention as described below.

(a) Performance functions are strictly increasing, the more varieties of products in each category, the greater the total performance of that category.

(b) They have diminishing returns for each successively added product. This is for two reasons. First, products are sorted by performance so that each added product is of a less popular variety than those already present. Second, products substitute as discussed earlier. Therefore, the more products in the category, the less likely that adding a new product will result in new customers who did not already find a product that they wanted in that category.

(c) If the number of products is 0, then the performance must also be 0.

(d) If the performance function is estimated based on the retailer's current products and performance for these products, the current number of products must correspond to current performance.

(e) The functions must show that if one or more currently sold products are removed, then remaining performance for the remaining products must be at least as great for the remaining products as it was before the removal. In fact, performance for the remaining products is probably greater than before the removal because it can be expected that some of the sales that are lost by the removal will be shifted over to the remaining products. In FIG. 4A, the bars represent the current sales of only the best selling product, the current sum of the two best products, and the current total sales of all the three products (from left to right), while the current number of products (i.e., 3) is being sold. The curve is an estimate of performance for these sets of products if only a particular set of products were sold. For example, while three products are being sold, the best two products have a performance of approximately 22,000. However, if one product is removed, thus leaving only the two best products, the projected performance is higher than the current performance. This occurs because if we removed some products then some of their sales would be substituted to the remaining products. For the current number of products the quantities coincide, however. Each of the three curves passes above the bars but coincides at the current number of products (i.e., 3). It should be noted that the bars are essentially the same as the traditional curve discussed earlier; and it should now be apparent that this conventional curve is unsuitable for predictions.

Even if all the criteria (a) to (e) are followed, each function is only a prediction of what will happen if one or more products is added or removed. Thus the performance function curves are different estimates, which use different mathematical functions.

The user can decide which performance function to use based on previous experience and experimentation. For example, when one or more products temporarily runs out of stock, the retailer can acquire data as to how the category would perform with less or different products. The invention is well suited for periodic use, for example every month or every quarter. When doing so, data can be saved from previous periods with different sales numbers and product counts. FIG. 4B illustrates the same situation as in FIG. 4A, except now the retailer is using data from one additional period. This makes it clear which of the performance functions are best in this example.

When data from past periods is used, the user should not use data from periods with a different external market environment. For example, in deciding the number of ice cream flavors to carry in the summer the retailer should not look at the sales of ice cream during the winter.

The following notation is used to describe functions herein. n is the total number of products in the category. P is the total performance of the category, as determined by evaluating the performance function for a particular number of products. In the example in FIG. 4A, total performance is revenue.

One of the curves uses a simple square root function, so that P=α√n, where α is a constant. Indeed, α can be determined by the current performance point; α=P(current)√N(current). In the example in FIG. 4A, α=1100.

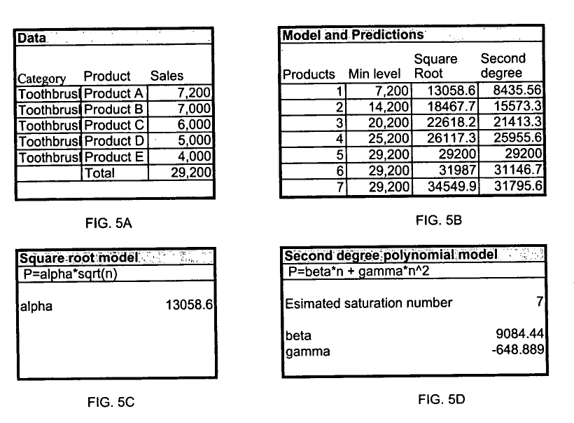

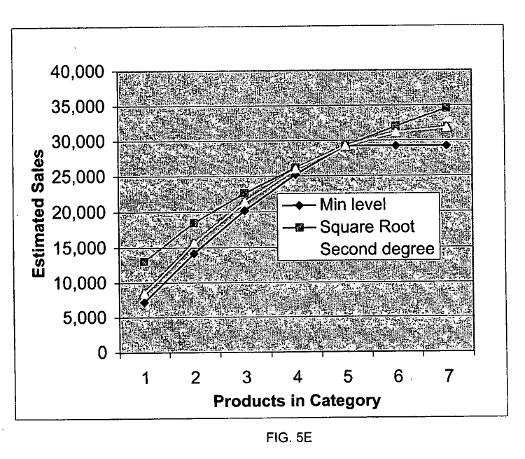

Another curve uses a second-degree polynomial, P=βn+γn\hat{ }2. Criterion (c) tells us that there can be no constant factor. But the current performance point is not enough to determine both β and γ. The polynomial will have some saturation point, after which adding more products will not further increase performance (mathematically speaking, the model would indicate that performance would decrease but the function should not be used for these decreasing values). However, if the user could provide some additional estimate, the function could be more precisely established. For example, perhaps the user believes that he knows where the saturation point is; in FIG. 4B the user has guessed that the current assortment is actually at saturation so that max performance is at 3. Retailers and other users of the invention may find it easier to estimate the maximum products that would bring any benefit, than to estimate slopes or parameters of an abstract performance function. Through differentiation one can mathematically show that the saturation point will be where β+2γn(saturation)=0. If the user estimates the saturation point based on experience, then we can calculate that γ=P(current)/(n(current)\hat{ }2−2n(current)n(saturation)) and γ=−2γn(saturation). FIGS. 5A-5D shows another prophetic example of calculating a performance function, using a spreadsheet program (Excel sold by Microsoft Corporation) which assists a user in selecting the proper model. In this case a macro was used for the optimization step. FIG. 5A shows the data fields, including the category, names of products and performance for each product. FIG. 5B shows the products ordered according to performance (i.e., first column), the actual level of performance at the current level of performance (i.e, $7,200 for the first best product, $14,200 for the two best products, etc.), and estimated performance levels based on square root and second-degree polynomial performance functions, respectively. FIGS. 5C and 5D show parameters that can be calculated for the square root model and second degree polynomial model, respectively. In the latter case, a saturation number of products is specified that will control the maximum performance and thus the parameters β and γ. The models curves are plotted, and the minimum possible level at each number (given by criterion (e)) is indicated in FIG. 5E.

The skilled artisan will understand that the performance function can be based on other functions, such as higher order polynomials, exponential functions, or splines (multiple low order polynomials often used to estimate arbitrary functions).

FIG. 4B shows a prophetic example of adding one additional data point to the situation described earlier in FIG. 4A. In this particular example the additional data point suggests that the polynomial function is the most accurate.

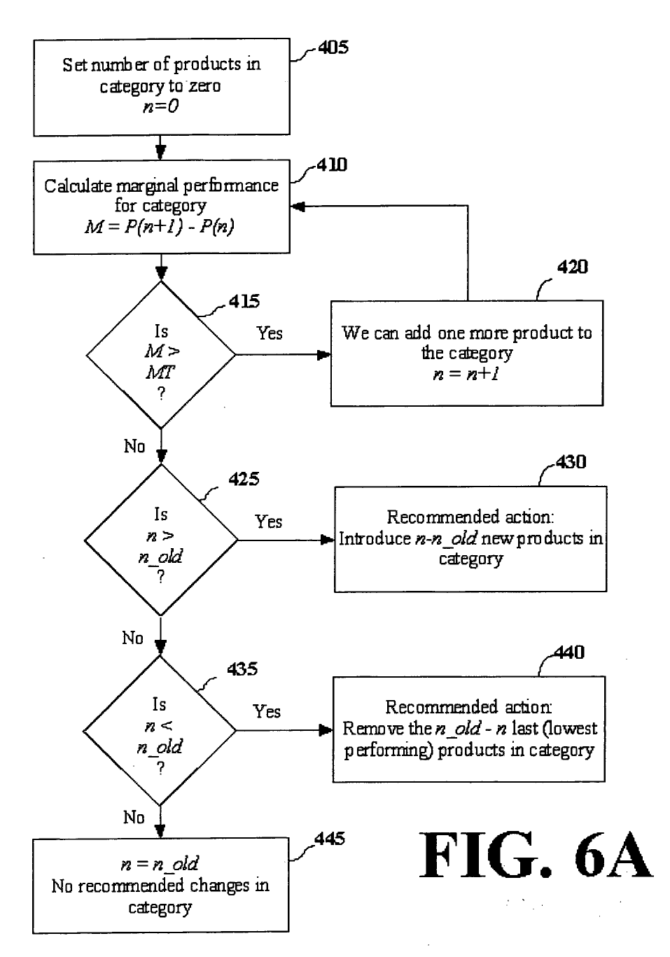

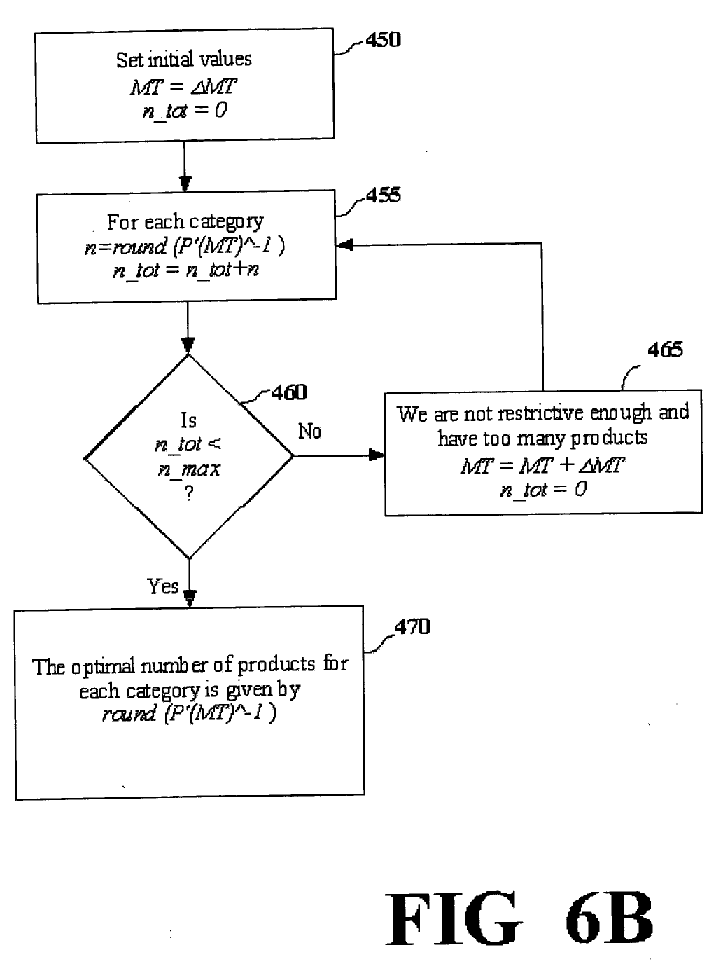

Once performance functions are chosen for all categories, optimization of the product assortment can be accomplished by a variety of methods, including by minimum threshold and by maximum performance. The idea for minimum threshold is that products should only be kept if they pass some basic threshold. Typically all carried products result in costs of inventory, tracking, labeling and so on, and products should not be carried unless they cover such costs. What is new with the present invention is that rather than looking at the sales numbers of the individual products, the user assess the likely overall impact of adding or removing the product; and demands that this difference (marginal performance) passes the threshold value. This marginal performance is different from the performance of the product itself, because adding or removing the product will also affect the performance of other products in the category. The process for minimum performance optimization is described in detail in FIG. 6A. It is performed independently for one category at a time. First, the number of products n is set to zero, as indicated in step 405. Next, the marginal performance M is calculated by evaluating the (previously established) performance function P for n+1 and n, and taking the difference (step 410). At 415, M is compared to the marginal performance threshold, MT. MT can be determined by the retailer/ user based on the retailer's costs associated with selling each product. If MT is larger than M, which is asked in 415, the user proceeds to step 420. In step 420, one more product is added to the category, and the process proceeds back to step 410. The process is repeated until M passes MT. Thus, the value of n is calculated and compared (steps 425 and steps 430) with the number of products that were previously in the same category earlier, i.e., n_old. If n is greater than n_old, than n minus n_old products should be added to the product category (step 425). In reaching this recommendation, the algorithm has already taken into account that new products will compete with existing products and that the newly added products are probably less popular than the currently sold product varieties. If n is lower than n_old, (step 435), n_old minus n products should be removed from the product category (step 440). As described above, the least popular product(s) should be removed. For small and/or poorly performing categories the recommendation may be zero products, in other words the category should be removed altogether. However, the skilled artisan will understand that because of substitution effects, the last remaining product in a category must be performing much worse to be removed, than a product in a category with many other products. The present invention takes this into account by the diminishing returns property of the category performance functions. Finally, if n is equivalent to n_old, the number of products in the product category should not be modified.

FIG. 6A illustrates a method for ensuring that all products perform above a pre-determined threshold. An alternative approach is to put a total limit, here n_max, on the number of products carried. N_max will generally be determined based on the amount of a retailer's finite space available for selling products. The optimization problem is then to find the maximum performing product combination for the entire product assortment that does not exceed n_max products across all categories. A process for finding this combination is illustrated in FIG. 6B. In the first step 450 n_tot, the number of products in all categories is initialized to zero. MT is initialized to some small value such as the step size ΔMT. The initial threshold should be sufficiently low so that at start the number of products calculated in step 455 is larger than n_max. In step 455, the inverse derivative of all performance functions is evaluated. For example, if the performance function is P=α√n, then the derivative P′ is α/(2√n). The inverse derivative is n=α\hat{ }2/(4(P′)\hat{ }2). Thus the marginal threshold is inserted so that P′=MT, and the corresponding value of n is calculated (the value must be rounded to get an integer n). Thus, step 455 is performed for every category. An alternative method to calculate n for each individual category is to reuse the process in FIG. 6A. In other words, the method goes from step 455 to step 405 for each category. The steps in FIG. 6A are followed until n has been calculated in step 425, at which point the user returns to step 455 in FIG. 6B with n calculated in an alternative way. The advantage with this variation is that the user does not have to evaluate inverse derivatives; the advantage of mathematical derivation is a simpler and less resource-demanding computer implementation. When either variation of the method has been completed for all categories, n_tot has been calculated and the user proceeds to step 460. Now n_tot is compared to the predetermined maximum n_max. If n_tot is larger than n_max, then the user of the method has to be more restrictive in which products he accepts. Thus, MT is increased by some small step ΔMT and the value of n is reset to 0 (step 465), and the process is repeated. The larger threshold will result in fewer accepted products, when the procedure returns to step 455 for at least one more iteration of calculating n for the different categories. Iterations continue until n_tot for the first time falls below the n_max (steps 460 and 470), at which point an improved performing product combination has been calculated (step 470).

As has been suggested previously the method can also be used for optimizing a limited space. In this case the performance functions are defined as performance per unit of room/ space. In other words performance functions are established as before except that they are divided with the typical product size (in some unit such as feet of shelf space) of the category (it is assumed that all products in a category have similar size). The maximum n_max is now redefined as the total space available (for example 500 linear feet of shelf space). The optimization algorithm described in FIG. 6B will calculate the distribution of products that utilizes the available space optimally.

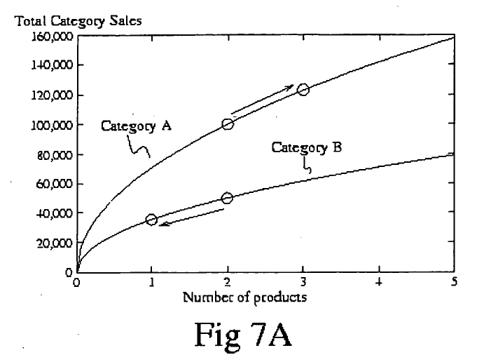

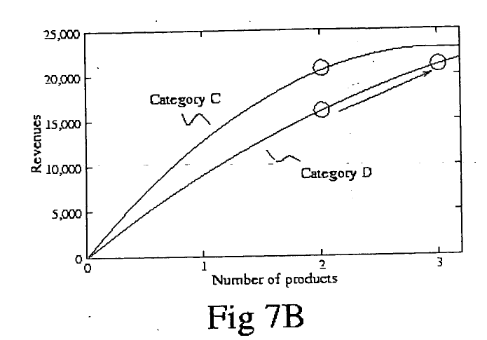

An example of a maximum performance optimization is illustrated conceptually in FIG. 7A. Product categories A and B have two products each and a current performance (revenues) of $100,000 and $50,000 respectively. The retailer only has room for 4 products total and is using the present invention to determine if he should modify the assortment. He has decided to use the square root model for both categories. These functions are plotted for categories A and B. An optimization is performed according to the process described in FIG. 7B, with a total number of products set unchanged at 4. The optimal solution is calculated to be 3 products for category A and 1 product for category B. The categories are expected to generate $122,000 and $35,000 with the new product counting for a total estimated improvement of $7,000.

In the conceptual plot in FIG. 7B, two products are in each in categories C and D. The retailer/user has decided to use a second-degree polynomial function with saturation points at 5 and 3 products, respectively for the two categories. In this example additional room has been identified and the retailer is considering which category to expand by one product. Category D has higher sales (both in absolute terms and in terms of sales per product), but on the other hand category C appears to be farther from the saturation point for that category. Using the present invention, it is calculated that category C should be expanded; the sales increase is higher than the one estimated for D. This recommendation defies the common sense approach of always expanding the higher performing categories.

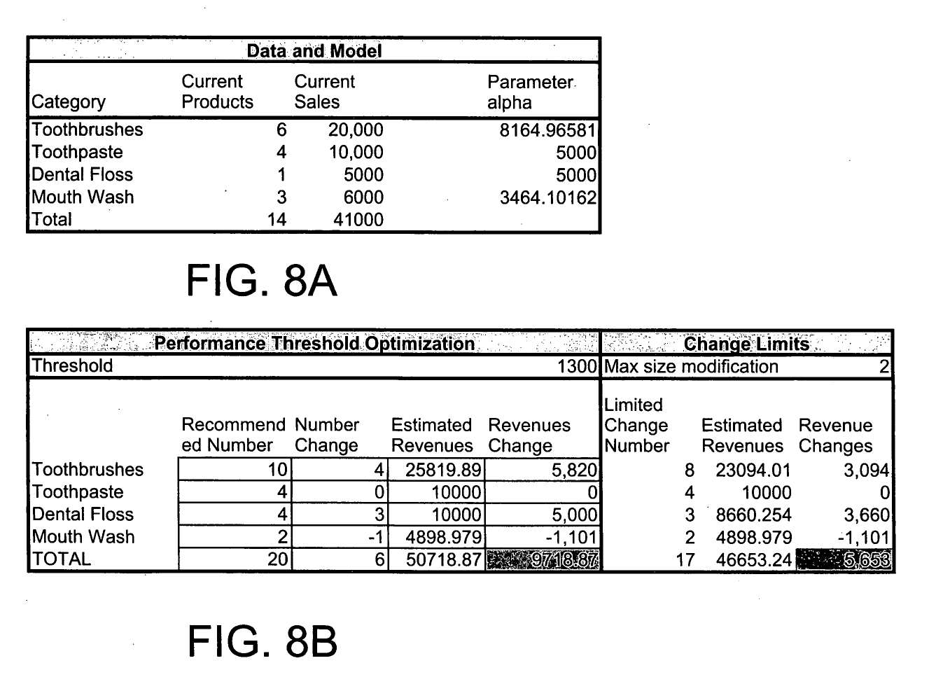

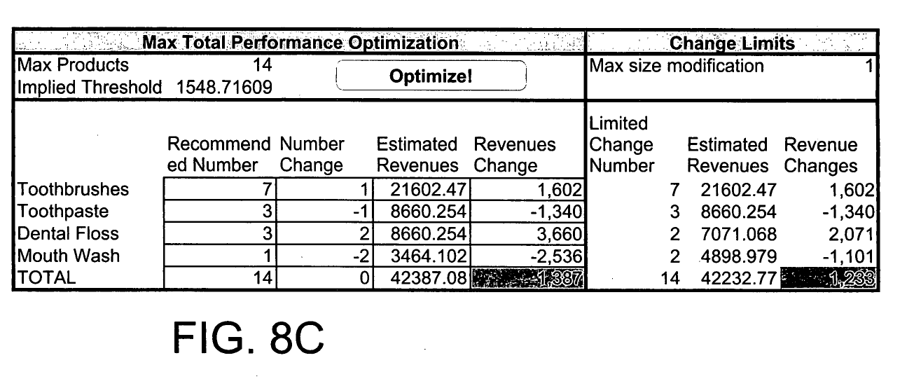

FIG. 8 shows the output of a software product (using spreadsheet and macros from Excel from Microsoft Corporation) of an optimization method and product of the invention. Here a user is trying to optimize four categories of dental products. While products such as toothbrushes and toothpaste are conventionally lumped together in a single category, the user has followed the present invention and put them in different categories because they do not substitute. In FIG. 8B, the user indicates the minimum performance threshold (i.e., 1300), and the number of products in each category is calculated following the method in FIG. 6A. The change in total revenues is displayed as well. In FIG. 8C, the user indicates the total number of products that can fit into the retailer's finite space (i.e., 14), and presses the “Optimize!” button. This activates a macro which performs an optimization in a way similar to that described in FIG. 6B. The number of products is updated and an implied threshold is indicated. This threshold value is useful as it indicates the marginal performance of the analyzed categories; in other words the value of the worst performing carried product. The marginal performance is also part of the calculation as indicated in step 465 in FIG. 6B. As discussed earlier it is preferable to limit dramatic changes when first using the invention to optimize a particular product category or product assortment. In FIGS. 8B and 8C it is thus possible to specify the maximum acceptable changes, in the shown examples 2 and 1, respectively. When the same product category or product assortment is being optimized after the first time using the invention, the performance functions can be updated with the experiences from the limited changes.

From the description above, a number of advantages of the present invention become apparent. The present invention enables a retailer to optimize the product assortment well beyond what has been previously possible. In the fiercely competitive retail business, this is the sort of competitive advantage that can make or break a retailer. The present invention does not only facilitate micro-management of separate categories, but helps in forming new strategies across categories as well.

This invention allows the retailer to optimize its product assortment to increase overall performance, even as this means comparing the proverbial apples and oranges. The method is easily adapted to optimize a limited space with products of different categories.

Alternatively, the retailer/user can use the invention to better than ever before understand the alternative costs of his products, rather than the prevalent and incorrect method of counting the literal costs. He can then make an accurate assessment of whether the products cover their cost to carry.

In spite of all these benefits the present invention does not require expensive external data sets, though such can be used within the confines of the invention. Neither are the algorithms very complex. The optimization process can be carried out using standard spreadsheet programs (e.g., Microsoft Excel) or it can be developed as an extra functionality for existing software (e.g., retail product databases).

Although the description above contains many specificities, these should not be construed as limiting the scope of the invention but as merely providing illustrative examples of some of the possible embodiments. For example, as most retailer's already have programs for organizing and studying their sales performance, the present invention would be well suited to add as an extra functionality to such software. This could be done through a standard package or a custom implementation. Some software products of the invention will further include the functionality of storing retail sales data, a retailer's product categories, and other information that may be useful to the retailer. For clarity the discussed examples have involved only one or two categories with a few common retail products each. In an actual implementation these numbers are likely to be much larger. Products may not be as concrete as those discussed here, the same methodology could be applied to for example to differentiated services.

1. A method for improving a retailer's total performance of a product assortment, comprising:
(a) categorizing the product assortment into a plurality of categories;
(b) calculating a performance function for at least one category that describes the relationship between the number of products in the category and the performance of that category, wherein the performance function predicts the effect of removing or adding category products on performance of the category; and
(c) improving the retailer's total performance by determining the number of products to sell in each category based on the performance function for each category.

2. The method of claim 1, wherein the step of categorizing the product assortment comprises categorizing the product assortment according to substitutability.

3. The method of claim 2, further comprising ordering the products in each category according to performance.

4. The method of claim 2, wherein products that are always or sometimes substituted for each other are placed in the same category.

5. The claim of 1, wherein performance is defined as revenue, profit or number of units sold.

6. The method of claim 1, wherein performance is defined as revenue divided by product size, profit divided by product size or number of units sold divided by product size.

7. The method of claim 3, wherein the step of improving the retailer's total performance comprises determining the number of products in each category whose addition to the category meets a performance measure.

8. The method of claim 3, wherein the step of improving the retailer's total performance comprises finding the number of products in each category which generates an optimized sum of performance for all categories.

9. The method of claim 3, wherein at least one performance function is calculated based on the retailer's performance data and product assortment.

10. The method of claim 3, wherein at least one performance function is calculated based on data from different time periods.

11. The method of claim 3, wherein at least one performance function has a diminishing performance for each additional product added.

12. The method of claim 3, wherein each performance function shows a performance value of zero when zero products are sold.

13. One or more computer-readable media comprising computer executable program instructions that, when executed, direct a computer system to:
(a) categorize the product assortment into a plurality of categories;
(b) calculate a function for each category that describes the relationship between the number of products in the category and the performance of that category, wherein the performance function predicts the effect of removing or adding category products on performance of the category; and
(c) improve the retailer's total performance by determining the number of products to sell in each category based on the performance function for each category.

14. The computer readable media of claim 13, wherein the program instructions, when executed, direct a computer system to categorize the product assortment by categorizing the product assortment according to substitutability.

15. The computer readable media of claim 14, further comprising program instructions that, when executed, direct the computer system to order the products in each category according to performance.

16. The computer readable media of claim 14, wherein the computer-executable program instructions, when executed, direct the computer system to categorize products into the same category if they are always or sometimes substituted for each other.

17. The computer readable media of claim 15, wherein the program instructions for improving the retailer's total performance, when executed, direct the computer system to determine the number of products in each category whose addition to the category meets a performance measure.

18. The computer readable media of claim 15, wherein the computer executable program instructions for improving the retailer's total performance, when executed, direct the computer system to iteratively increase a performance measure that each product must meet until the total number of products across all categories is not greater than the total number of products that the retailer can carry, wherein the performance measure tests the increase in category performance likely to be caused by adding each product to its category.

19. The computer readable media of claim 15, further comprising computer-executable program instructions that, when executed, direct the computer system to calculate at least one performance function based on the retailer's performance data and product assortment.

20. The computer readable media of claim 15, further comprising computer-executable program instructions that, when executed, direct the computer system to calculate at least one performance function based on data from different time periods.

21. The computer readable media of claim 15, further comprising computer-executable program instructions that, when executed, direct the computer system to calculate at least one performance function that has a diminishing performance for each additional product added.

22. The computer readable media of claim 15, further comprising computer-executable program instructions that, when executed, direct the computer system to calculate each performance function to have a performance value of zero when zero products are sold.

23. A method of categorizing products in a product assortment, comprising
(a) grouping products that customers do not substitute for each other into different categories; and
(b) grouping products that customers sometimes or always substitute for each other into the same category.

24. The method of claim 23, further comprising ordering the products in each of said categories according to the order of their performance.
